(19) United States
(12) Patent Application Publication
(10) Pub. No.: US 2014/0154540 A1
(43) Pub. Date: Jun. 5, 2014

(54) POWER BATTERY COVER PLATE EQUIPPED WITH A CURRENT INTERRUPTION DEVICE

(71) Applicant: NINGDE AMPEREX TECHNOLOGY LIMITED, Ningde City (CN)

(72) Inventors: Zhijun GUO, Ningde City (CN); Peng Wang, Ningde City (CN); Pinghua Deng, Ningde City (CN); Kai Wu, Ningde City (CN)

(73) Assignee: NingDe Amperex Technology Limited, Ningde City (CN)

(21) Appl. No.: 13/773,867

(22) Filed: Feb. 22, 2013

(30) Foreign Application Priority Data
Dec. 3, 2012 (CN) 201220651947.5

(51) Int. Cl. H01M 2/04

(52) U.S. Cl. CPC H01M 2/04
USPC 429/82

(57) ABSTRACT

The invention pertains to the field of battery technology, in particular to a power battery cover plate equipped with a current interruption device, comprising a cover plate, a positive Terminal, a vent and a negative teminal, wherein, the positive Terminal, the vent and the negative teminal are installed on the cover plate; the negative teminal comprises an upper part of the negative teminal and a lower part of the negative teminal, in which, the lower part of the negative teminal is assembled with the upper part of the negative teminal in an insulated and sealed way, the upper part of the negative teminal is connected with the lower part of the negative teminal via an elastic connector, the lower part of the negative teminal is provided with a notch to which the elastic connector is corresponding to.

### FIELD OF THE INVENTION

The invention pertains to the field of battery technology, in particular to a power battery cover plate equipped with a current interruption device.

### BACKGROUND OF THE INVENTION

With development of modern society and strengthening of environmental protection consciousness, more and more devices can be equipped with selectable and rechargeable secondary batteries as power supply thereof, such as mobile phones, notebook computers, power tools, electric automobiles and so on; especially electric automobiles and energy storage need a power battery of large capacity, which on one hand provides broad space for application and development of rechargeable secondary batteries, on the other hand raises higher demands for batteries, for example, batteries are expected to have higher capacity, good safety and longer cycle life etc. Once an accident occurs on a battery when it is subject to improper battery charging, short circuit or exposure to high temperature and other severe environment, the high energy battery may produce a large amount of gas, with temperature rising sharply. A conventional battery is decompressed by a pressure relief valve instead of switching off battery cell return circuit. Consequently, larger safe accidents may be resulted from continuous overcharge of a battery which has an accident.

### SUMMARY OF THE INVENTION

The invention aims at, in allusion to disadvantages of the prior art, providing a power battery cover plate equipped with a current interruption device, wherein a current interruption structure is disposed on the negative teminal for switching off current circuit via internal pressure, which can prevent a battery which has an accident from over-charging, thus avoiding larger safe accidents resulted from the accident.

For achieving the above-mentioned objectives, the invention adopts a technical scheme as below: a power battery cover plate equipped with a current interruption device, comprising a cover plate, a positive Terminal, a vent and a negative teminal, wherein, the positive Terminal, the vent and the negative teminal are installed on the cover plate;

The negative teminal comprises an upper part of the negative teminal and a lower part of the negative teminal, in which, the lower part of the negative teminal is assembled with the upper part of the negative teminal in an insulated and sealed way, the upper part of the negative teminal is connected with the lower part of the negative teminal via an elastic connector, the lower part of the negative teminal is provided with a notch to which the elastic connector is corresponding to.

The cover plate is shaped like a rectangle, a round or an oval.

The notch is shaped like a round or an oval.

The notch has a depth of 0.05-2 mm.

The notch has a depth of 0.1-1 mm.

The upper part of the negative teminal is, successively through a nut, an insulating located block and a sealing ring, installed on the cover plate in an insulated and sealed way.

The upper part of the negative teminal is, via a spacer, arranged on the lower part of the negative teminal.

The invention has a beneficial effect in that: the power battery cover plate equipped with a current interruption device, comprising a cover plate, a positive Terminal, a vent and a negative teminal, wherein, the positive Terminal, the vent and the negative teminal are installed on the cover plate;

The negative teminal comprises an upper part of the negative teminal and a lower part of the negative teminal, in which, the lower part of the negative teminal is assembled with the upper part of the negative teminal in an insulated and sealed way, the upper part of the negative teminal is connected with the lower part of the negative teminal via an elastic connector, the lower part of the negative teminal is provided with a notch to which the elastic connector is corresponding to. When the internal air pressure rises resulted from an accident of an battery cell, a ring piece in the notch is broken through by the elastic connector, so that the upper part of the negative teminal is completely separated from the lower part of the negative teminal, thus rupturing current, preventing the battery cell from overcharging in case of an accident, and avoiding larger safe accidents resulted from the accident.

### BRIEF DESCRIPTION OF THE DRAWINGS

FIG. 1 is a vertical view of the invention;

FIG. 2 is a front view of the invention;

FIG. 3 is an enlarged view of the negative teminal structure in FIG. 2; and

FIG. 4 is an exploded view of the invention.

### DETAILED DESCRIPTION OF THE PREFERRED EMBODIMENTS

The invention is further described in detail with embodiments and attached drawings. However, the invention is not limited to the mode of execution.

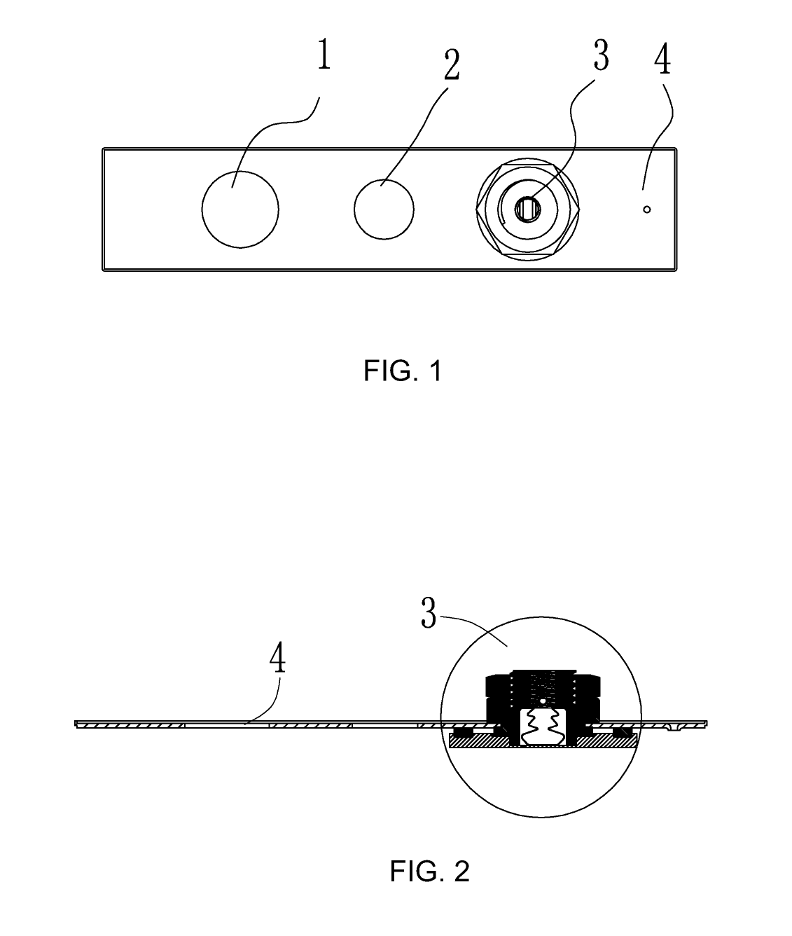

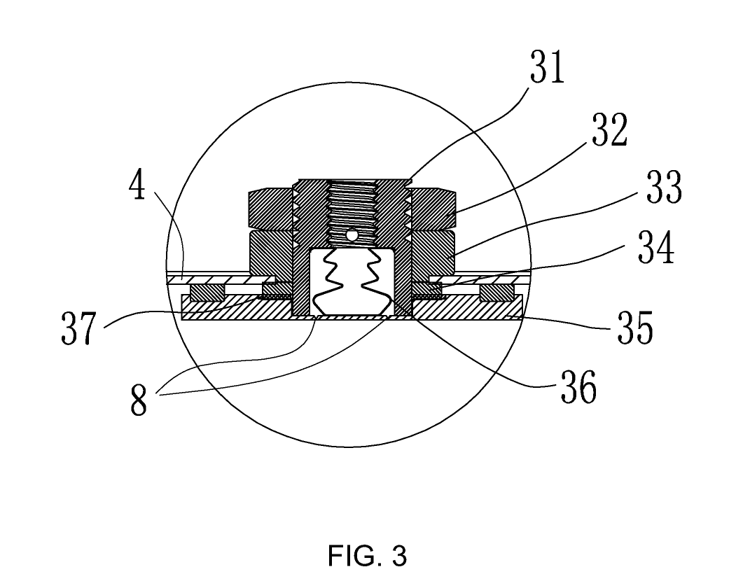

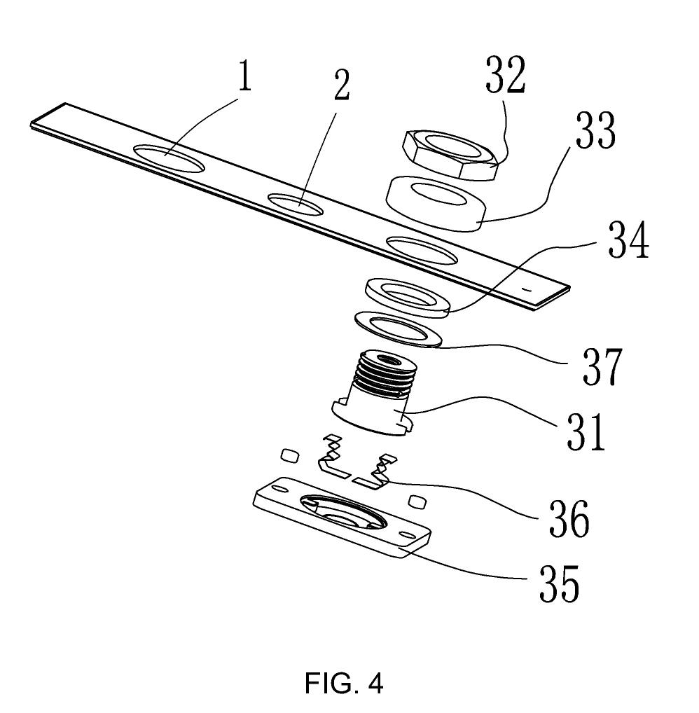

Just shown as FIG. 1-4, a power battery cover plate equipped with a current interruption device, comprising a cover plate 4, a positive Terminal 1, a vent 2 and a negative teminal 3, wherein, the positive Terminal 1, the vent 2 and the negative teminal 3 are installed on the cover plate 4;

The negative teminal 3 comprises an upper part of the negative teminal 31 and a lower part of the negative teminal 35, in which, the lower part of the negative teminal 35 is assembled with the upper part of the negative teminal 31 in an insulated and sealed way, the upper part of the negative teminal 31 is connected with the lower part of the negative teminal 35 via an elastic connector 36, the lower part of the negative teminal 35 is provided with a notch 8 to which the elastic connector 36 is corresponding to.

Preferably, the cover plate 4 is shaped like a rectangle, a round or an oval.

Preferably, the notch 8 is shaped like a round or an oval.

The notch 8 has a depth of 0.05-2 mm.

Preferably, the notch 8 has a depth of 0.1-1 mm; generally, the notch 8 has a depth of about 0.25 mm; this is because under modulating control of such a depth, the ring piece in the notch 8 can be subject to a full rupture under an air pressure of 0.3 MPa-0.5 MPa, thus achieving the function of rupturing current.

Preferably, the upper part of the negative teminal 31 is, successively through a nut 32, an insulating located block 33 and a sealing ring 34, installed on the cover plate 4 in an insulated and sealed way. Insulation can be achieved by adopting surface spray coating and electroplating etc.

The upper part of the negative teminal 31 is, via a spacer 37, arranged on the lower part of the negative teminal 35. And the upper part of the negative teminal 31 is fixed to the lower part of the negative teminal 35 by the spacer 37.

From above description, those skilled in the art can change or modify the above-mentioned embodiments. Therefore, the invention is not limited to the above-mentioned embodiments. All obvious improvements, substitutions or modifications of the invention made by those skilled in the art are within the scope of protection of the invention. In addition, some specific terms are used in the specification for the convenience of description, but not to limit the invention.

What is claimed is:

1. A power battery cover plate equipped with a current interruption device, comprising a cover plate (4), a positive Terminal (1), a vent (2) and a negative teminal (3), wherein, the positive Terminal (1), the vent (2) and the negative teminal (3) are installed on the cover plate (4);
the negative teminal (3) comprises an upper part of the negative teminal (31) and a lower part of the negative teminal (35), wherein the lower part of the negative teminal (35) is assembled with the upper part of the negative teminal (31) in an insulated and sealed way, the upper part of the negative teminal (31) is connected with the lower part of the negative teminal (35) via an elastic connector (36), the lower part of the negative teminal (35) is provided with a notch (8) to which the elastic connector (36) is corresponding to.

2. The power battery cover plate equipped with a current interruption device of claim 1, wherein the cover plate (4) is shaped like a rectangle, a round or an oval.

3. The power battery cover plate equipped with a current interruption device of claim 1, wherein the notch (8) is shaped like a round or an oval.

4. The power battery cover plate equipped with a current interruption device of claim 3, wherein the notch (8) has a depth of 0.05-2 mm.

5. The power battery cover plate equipped with a current interruption device of claim 4, wherein the notch (8) has a depth of 0.1-1 mm.

6. The power battery cover plate equipped with a current interruption device of claim 1, wherein the upper part of the negative teminal (31) is, successively through a nut (32), an insulating located block (33) and a sealing ring (34), installed on the cover plate (4) in an insulated and sealed way.

7. The power battery cover plate equipped with a current interruption device of claim 6, wherein the upper part of the negative teminal (31) is, via a spacer (37), arranged on the lower part of the negative teminal (35).
